(19) United States
(12) Patent Application Publication
(10) Pub. No.: US 2022/0318931 A1
(43) Pub. Date: Oct. 6, 2022

(54) SYSTEM AND METHOD FOR ONLINE SOCIAL AND PROFESSIONAL NETWORKING

(71) Applicant: Delvin Sekou Prince, Port Saint Lucie, FL (US)

(72) Inventor: Delvin Sekou Prince, Port Saint Lucie, FL (US)

(21) Appl. No.: 17/692,829

(22) Filed: Mar. 11, 2022

Related U.S. Application Data
(60) Provisional application No. 63/170,497, filed on Apr. 4, 2021.

(51) Int. Cl. G06Q 50/00; G06Q 10/10

(52) U.S. Cl. CPC G06Q 50/01; G06Q 10/1053; G06Q 10/1093

(57) ABSTRACT

A system and method that allow members of a community to both socially and professionally connect, thus catering to diverse needs of a group of people. The members can connect with each other to track and attend public event, participate in indoor and outdoor activities, post job requirements, and the like day to day needs.

### CROSS-REFERENCE TO RELATED APPLICATIONS

This application claims priority from the U.S. provisional patent application Ser. No. 63/170,497, filed on Apr. 4, 2021, which is incorporated herein by reference in its entirety.

### FIELD OF INVENTION

The present invention relates to a system and method for an online networking platform, and more particularly, the present invention relates to a platform for social and professional networking.

### BACKGROUND

Technology has been a gift for humanity by bringing people closer together. Through modern technology, people can easily communicate with other people irrespective of the physical distances between the two. A variety of online networking platforms are available that allow people to connect and keep in touch with their loved ones, family member, and friends. Moreover, the available networking platforms allow people to connect and know people around the world whom they have never met before. Besides social networking, platforms are also available for professional networking wherein the members of the platform can showcase their professional resumes and connect with other professionals. Thus, a variety of platforms are available for solving a variety of problems or to cater to the different needs of humans and make life easier and more prosperous. However, the available platforms cater to the specific needs of the general public.

Currently, a user must engage with different online platforms for different needs. The user has to make a profile for each platform that requires both time and effort. The user often finds it difficult to follow several platforms or track different profiles.

Thus, a need is there for a novel online platform that can cater to the different social and professional needs of a specific group of people.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an online platform for people in a neighborhood or community to connect.

It is another object of the present invention that the online platform allows its members to socialize with other members.

It is still another object of the present invention that the online platform allows its member to professionally connect with other members of the platform.

It is yet another object of the present invention that the online platform provides for a single interface to both socially and professionally connect with different members.

It is a further object of the present invention that the online platform allows connecting members to new members in a community.

In one aspect, disclosed is a system for social and professional networking, the system comprising a processor and a memory both operably coupled to each other, the system configured to implement a method comprising the steps of providing an interface, by an interface module upon execution by the processor, on a user device; presenting a home screen through the interface on the user device, the home screen comprises links to a business connection screen and a personal connection screen; presenting the business connection screen upon clicking a first link; presenting a first menu associated with the business connection screen; presenting the personal connection screen upon clicking a second link; and displaying a second menu associated with the personal connection screen.

In one aspect, disclosed is a method for social and professional networking, the method implemented within a system, the method comprising the steps of providing an interface, by an interface module upon execution by the processor, on a user device; presenting a home screen through the interface on the user device, the home screen comprises links to a business connection screen and a personal connection screen; presenting the business connection screen upon clicking a first link; presenting a first menu associated with the business connection screen; presenting the personal connection screen upon clicking a second link; and displaying a second menu associated with the personal connection screen.

In one implementation of the method, the method further comprises the steps of permitting a user to set up an account by providing user details, the user details comprise name, address, and contact number. The method further comprises the steps of providing an event screen, through the interface, implemented to allow posting and tracking a plurality of events; and inventing members, through the interface, interested in an event of the plurality of events to plan and attend the event. The method further comprises the steps of posting a job requirement, through the interface, wherein a plurality of members of the system, through the interface, can view and respond to the job requirement.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the system, according to an exemplary embodiment of the present invention.

FIG. 2 shows a home page of the disclosed interface implemented on a user device, according to an exemplary embodiment of the present invention.

FIG. 3 shows a personal profile, according to an exemplary embodiment of the present invention.

FIG. 4 shows a business profile, according to an exemplary embodiment of the present invention.

FIG. 5 shows a personal menu, according to an exemplary embodiment of the present invention.

FIG. 6 shows a business menu, according to an exemplary embodiment of the present invention.

FIG. 7 shows a login screen of the interface, according to an exemplary embodiment of the present invention.

FIG. 8 shows a screen for existing connections, according to an exemplary embodiment of the present invention.

FIG. 9 shows a screen to set up an account, according to an exemplary embodiment of the present invention.

FIG. 10 shows a screen for network meeting, according to an exemplary embodiment of the present invention.

FIG. 11 shows a screen for event confirmation, according to an exemplary embodiment of the present invention.

FIG. 12 shows a chat screen, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a system and method for providing a platform for social and professional networking by a group of people, the group of people can be a neighborhood, community, city, and the like. This allows the neighbors with similar interests who wouldn't normally be able to communicate to easily connect. The members can share the detail of events in their community such as dating, one-on-one meetings, sports activities, recreation activities, family connections, and more. The disclosed platform can be useful for the professionals looking for work, or individuals looking for an occupation in their area, networking, and business-related experiences. An average person with limited income can easily advertise her/his talents, skills, trade, and more on the disclosed platform. The disclosed platform can allow the professional people in a community who have free time and are willing to help out other members of the community without the cost of a major corporation or business. Members of the platform can advertise their profession, certifications, highlight their skills, accomplishments, references, present their resume and qualifications, availability, desires/budget, home base, etc. At the same time, other members of the community that are also consumers can connect to the professional and knowledgeable people in their desired area of interest.

On the personal side, the same platform can allow the members in setting up connections for future events, gatherings, sporting events, tailgating, concerts, picnics, parties, and more. For example, a person looking to attend a public event can reach out to other known or unknown members of the platform also interested to attend the event. The disclosed platform can allow such members to plan, meet, rent a vehicle, and a driver for the group to safely reach to and from the event. Such public events can be advertised on the disclosed platform by any member of the platform or any of the administrators. The listed public event can be tracked by the members to know the near real-time status, members showed interest to attend the public event, members going to the event, update availability, comment, and the like.

Many indoor and outdoor activities require participants in teams, such as football, basketball, and the like. The disclosed platform can allow members in a neighborhood to associate for day-to-day activities such as going to a park to play, playing football, or basketball, and the like. A member can send out a ping to let other members of the platform in the neighborhood know about the member looking for players who are interested in running a full court. Similarly, a member in a bar, nightclub, or any location and interested in meeting/dating someone, the member through the disclosed platform can let it be known to all those in the vicinity and are willing to meet face-to-face after accepting a connection request.

The members can view others' profiles, uploaded pictures, likes, interests, hobbies, as common interests. Once a Connection Opportunity is created it is then posted to the Existing Connection Request board where other Connectors in the area will be able to see his/her status update, respond, and more.

The utility providers in a community, such as Gym facilities, Dance teachers, electricians, plumbers, and the like can advertise on the disclosed platform. The members of the platform in the community can search for the services they need through an interface provided by the platform. A single platform can cater to the different needs of the people including day-to-day needs. The members can get a quick response from the nearby service providers tailored to a specific audience. The members do not have to search any directory for the contact information of the service providers and call them. Neither the members have to call their neighbors to get information for plumber or electrician. On the same disclosed platform, the member can simply post “need an electrician” and the nearby electrician can respond to the post.

Any notification (ping) a user receives is based on the job preference/skill on his business profile, or interest/passion on his personal profile. Unlike most platforms that rely on a friends list or followers, the disclosed platform includes everyone around who possesses the app. A user can connect with people, he never met or talked to before that have a skill, talent, or similar interest the user is looking for. No friend list or follower kind of requirement is needed in the disclosed platform. A major drawback of known social platforms is to search for connection opportunity requests which is both tedious and time consuming. The disclosed platform can be particularly advantageous by notifying the members via ping/message for new connection opportunities.

The listing, events, and the like can be shown to a member based on his interest. The areas of interest can be received from the member as well as the members can be allowed to modify their interests. The areas of interest can be presented through an interface implemented by the disclosed system, as a list from which the user can select and deselect areas of interest.

The Connector is simple yet sophisticated. Most of all, Connector is convenient because the user can connect to the world around them, and their interests, with ease. People can connect through key words in the user's settings/profile & connection request.

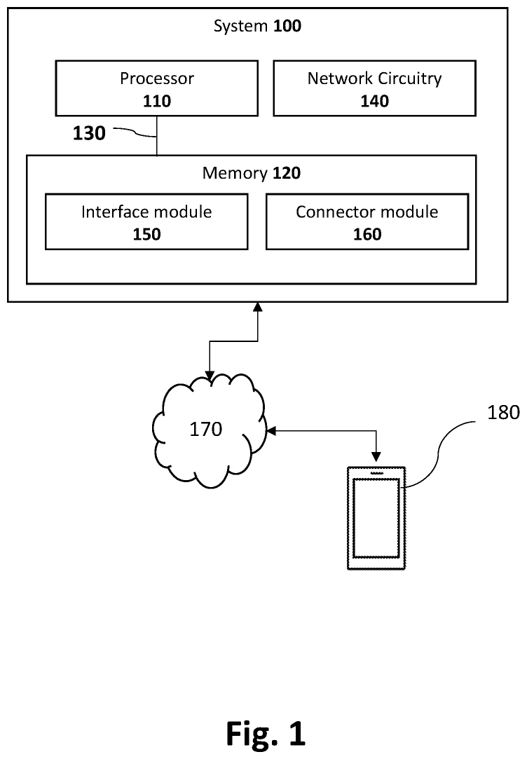

Referring to FIG. 1, which is a block diagram showing an exemplary embodiment of the disclosed system 100 for social and professional networking among a community or neighborhood. The system 100 can include a processor 110 coupled to a memory 120 through a system bus 130. The system 100 may also include a network circuitry 140 coupled to the processor through the system bus 130 for connecting the system 100 to an external network 170. The processor 110 can be any logic circuitry that responds to and processes instructions fetched from the memory 120. Suitable examples of the processors commercially available include Intel and AMD. The memory 120 may include one or more memory chips capable of storing data and allowing any storage location to be directly accessed by the processor 110. FIG. 1 shows the system 100 that can interact with one or more user devices 180 through the external network 170. The user devices can be computer devices with network connectivity, and examples of the user device may include a smartphone, laptop, desktop, tablet computer, personal digital assistant (“PDA”). The user device can include a suitable operating system, such as but not limited to Android, iOS, Windows, macOS, blackberry, and Linux. The user device can have an input device for receiving an input and a display for a user to interact with the disclosed system 100.

While, for the purpose of illustration herein, FIG. 1 shows the user device 180 and the system 100 connected through the same network, it should be obvious to those reading this disclosure that the different user devices can connect with the disclosed system through different networks and using different network communication protocols. Moreover, the same device can connect with the system 100 through more than one network. The network can be a secure network or an unsecured network. Moreover, the network can be wired or wireless network. The wired network may include DSL and optical fiber lines. The wireless network may include Bluetooth®, Wi-Fi, WiMAX, and cellular networks including GPRS, LTE, CDMA, 3G, 4G, and 5G.

The terms “user” and “member” are interchangeably used herein, and throughout this disclosure, refers to an individual engaging a user device according to embodiments of the invention with the disclosed system.

Again, referring to FIG. 1, memory 120 includes modules according to the present invention for execution by the processor 110 to perform one or more steps of the methodology disclosed herein. The memory 120 can include an interface module 150 and a connector module 160. The interface module 150 which upon execution by the processor can provide an interface for the users to interact with the disclosed system and includes downloading and uploading information to and from the system 100. The interface can be provided as application software that can be installed on the user device 180. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS. The user interface may permit interacting with a user through the user device, wherein information can be presented within the user interface by the system 100 and information can be received by the system 100 from the user.

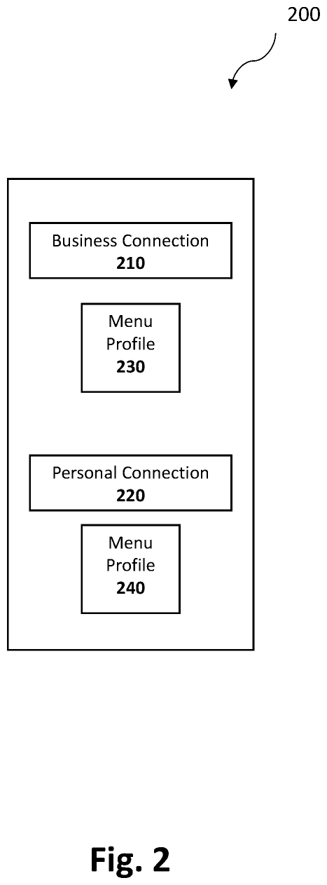

FIG. 2 shows a home page 200 of the disclosed interface implemented on the user device. The home page allows users to select either the business connection 210 or a personal connection 220, both provided on the same page. A menu profile 230 can be provided for the business connection 210 and a separate menu profile 240 can be linked to the personal connection 220.

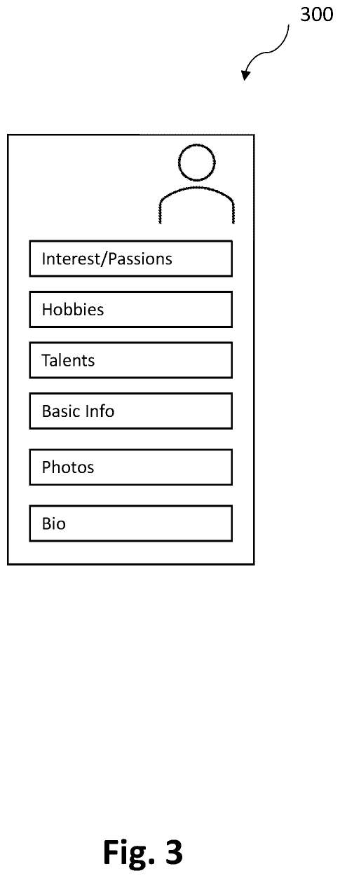

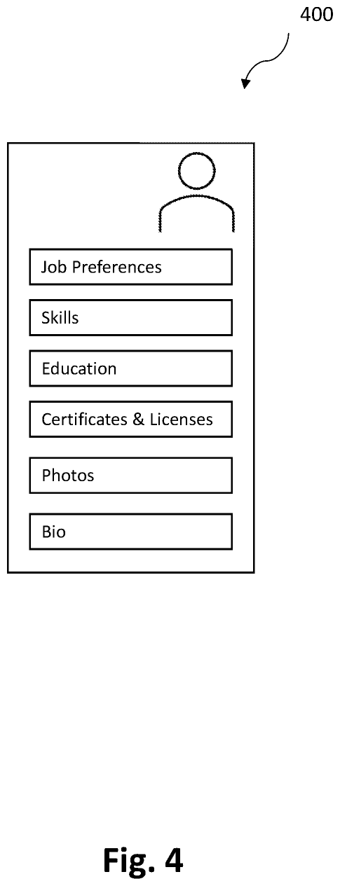

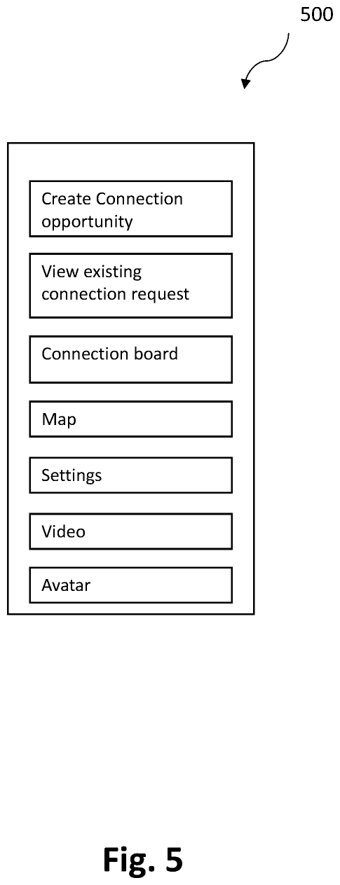

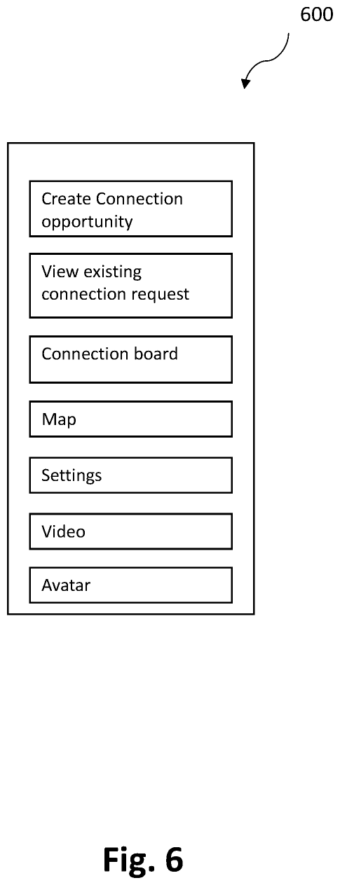

FIG. 3 shows the personal profile 300 linked to the menu profile 240 and FIG. 4 shows business profile 400 linked to the menu profile 230. FIG. 5 shows a personal menu 500 of the interface that allows users to interact with other members and the system 100. FIG. 6 shows a business menu 600 of the interface that allows the user to interact with other members and the system 100.

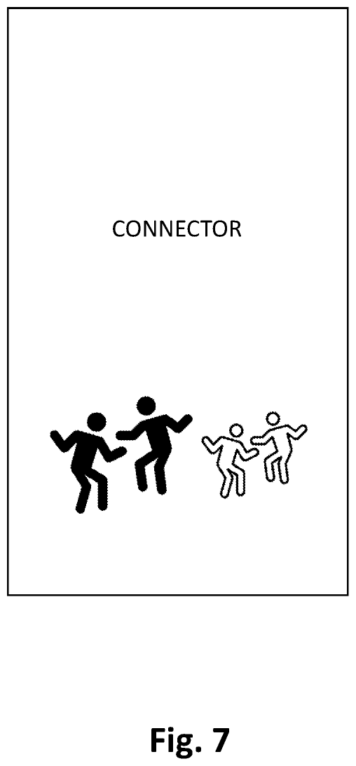

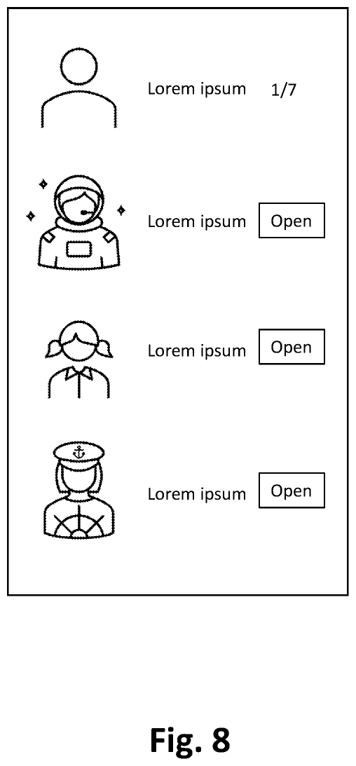

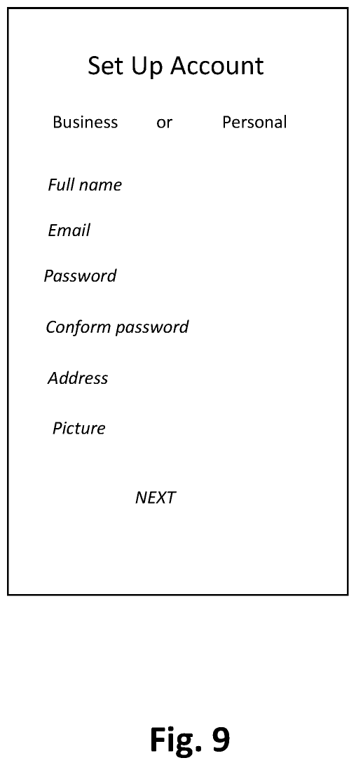

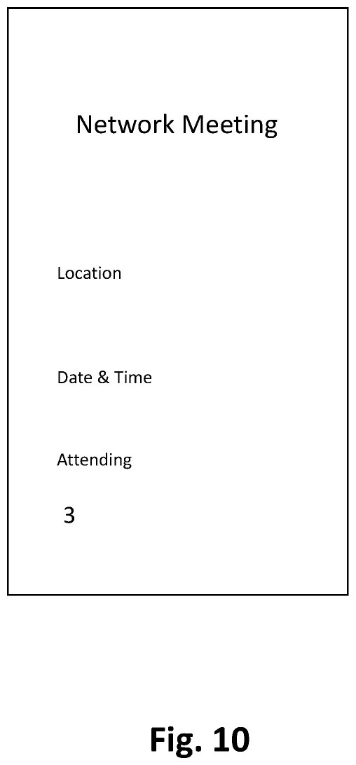

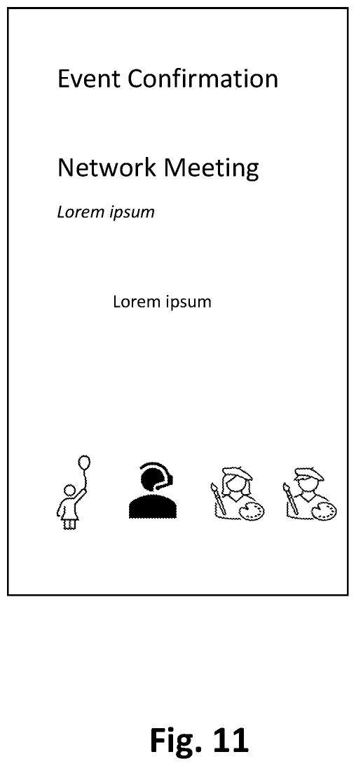

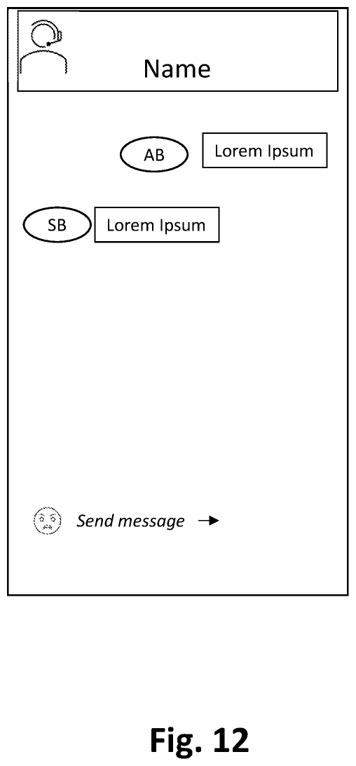

FIG. 6 shows a business menu, FIG. 7 shows a login screen of the interface, FIG. 8 shows a screen for existing connections, FIG. 9 shows a screen to set up an account, FIG. 10 shows a screen for network meeting, FIG. 11 shows a screen for event confirmation, and FIG. 12 shows a chat screen.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for social and professional networking, the system comprising a processor and a memory both operably coupled to each other, the system configured to implement a method comprising the steps of:
providing an interface, by an interface module upon execution by the processor, on a user device;
presenting a home screen through the interface on the user device, the home screen comprises links to a business connection screen and a personal connection screen;
presenting the business connection screen upon clicking a first link;
presenting a first menu associated with the business connection screen;
presenting the personal connection screen upon clicking a second link; and
displaying a second menu associated with the personal connection screen.

2. The system according to claim 1, wherein the method further comprises the steps of:
permitting a user to set up an account by providing user details, the user details comprise name, address, and contact number.

3. The system according to claim 2, wherein the method further comprises the steps of:
providing an event screen, through the interface, implemented to allow posting and tracking a plurality of events; and
inventing members, through the interface, interested in an event of the plurality of events to plan and attend the event.

4. The system according to claim 3, wherein the method further comprises the steps of:
posting a job requirement, through the interface, wherein a plurality of members of the system, through the interface, can view and respond to the job requirement.

5. A method for social and professional networking, the method implemented within a system comprising a processor and a memory, the method comprising the steps of:
providing an interface, by an interface module upon execution by the processor, on a user device;
presenting a home screen through the interface on the user device, the home screen comprises links to a business connection screen and a personal connection screen;
presenting the business connection screen upon clicking a first link;
presenting a first menu associated with the business connection screen;
presenting the personal connection screen upon clicking a second link; and
displaying a second menu associated with the personal connection screen.

6. The method according to claim 5, wherein the method further comprises the steps of:
permitting a user to set up an account by providing user details, the user details comprise name, address, and contact number.

7. The method according to claim 6, wherein the method further comprises the steps of:
providing an event screen, through the interface, implemented to allow posting and tracking a plurality of events; and
inventing members, through the interface, interested in an event of the plurality of events to plan and attend the event.

8. The method according to claim 7, wherein the method further comprises the steps of:
posting a job requirement, through the interface, wherein a plurality of members of the system, through the interface, can view and respond to the job requirement.
